(19) United States
(12) Patent Application Publication
(10) Pub. No.: US 2008/0266323 A1
(43) Pub. Date: Oct. 30, 2008

(54) Augmented reality user interaction system

(75) Inventors: Frank Biocca, East Lansing, MI (US); Charles B. Owen, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 11/789,488

(22) Filed: Apr. 25, 2007

(51) Int. Cl. G09G 5/00

(52) U.S. Cl. 345/633; 345/156; 345/8; 382/154

(57) ABSTRACT

An augmented reality user interaction system includes a wearable computer equipped with at least one camera to detect one or more fiducial markers worn by a user. A user-mounted visual display worn by the user is employed to display visual 3D information. The computer detects in an image a fiducial marker worn by the user, extracts a position and orientation of the fiducial marker in the image, and superimposes on the image a visual representation of a user interface component directly on or near the user based on the position and orientation.

### STATEMENT OF GOVERNMENT INTEREST

This invention was made with United States government support under National Science Foundation Contract No. 0222831. The United States government may have certain rights in this invention.

### FIELD OF THE INVENTION

The present invention is related generally to mobile, wearable computing systems, and more particularly to systems that use augmented reality displays involving head-mounted displays.

### BACKGROUND OF THE INVENTION

Augmented reality (hereinafter “AR”) is the modification of human perception of the environment through the use of computer-generated virtual augmentations. AR realizations include modifications of video to include virtual elements not present in the original image, computer displays with cameras mounted on the head, so as to simulate the appearance of a see-through display, and head-mounted displays that overlay computer generated virtual content onto a user's field of vision. Augmented reality displays allow for the display of information as if it were attached to objects in the world or free-floating as if in space. Head mounted display technologies include see-through displays that optically compose computer-generated augmentations with the user's field of view, displays where a user is viewing the world through a monitor and the augmentations are electronically combined with real-world imagery captured by a camera, and retinal scan displays or other embodiments that compose the virtual annotations with the real-world imagery on the retina of the eye. In all cases, virtual elements are added to the world as perceived by the user.

A key element of augmented reality systems is the ability to track objects in the real world. AR systems overlay virtual content onto images from the real world. In order to achieve the necessary registration between the virtual elements and real objects, a tracking system is required. Tracking is the determination of the pose (position and orientation) of an object or some part of the user in space. As an example, a tracking system may need to determine the location and orientation of the hand so as to overlay a menu onto the image of the hand as seen by a mobile AR user. Tracking is responsible for determining the position of the hand, so that graphics can be rendered accurately.

One approach to tracking is the placement of a pattern onto the object that is to be tracked. This pattern, sometimes referred to as a fiducial or marker, is captured by a camera, either in the image to be augmented or by a dedicated tracking system. The pattern is unique in the environment and designed to provide a tracking system with sufficient information to locate the pattern reliably in the image and accurately determine the pose of the pattern and, thereby, the pose of the object that pattern is attached to.

Several kinds of fiducials have been used in the Augmented Reality community. For example, the popular ARToolkit uses black squares with arbitrary patterns inside as fiducials. Other researchers have based their fiducials on 2D barcode technology. Still other researchers have used circular 2D bar coded fiducials. More recently, a fiducial marker system called ARTag has been proposed for achieving lower false positive error rate and lower inter-marker confusion rate than the ARToolkit fiducials.

Different approaches have been developed in the course of exploring the use of tracking with and without fiducials. For example, a hybrid tracking method has been developed that takes advantage of the registration accuracy of vision-based tracking systems and the robustness of magnetic tracking systems. Also, other researchers have defined a virtual workspace based upon motion analysis of the input video stream. Yet other researchers have described a basic tracking system using fiducials attached to objects.

Position and orientation sensing methods have also been explored. In particular, some researchers have provided a three-dimensional position and orientation sensing method that uses three markers whose 3D locations with respect to an object to be measured are known in advance. The three-dimensional position and orientation of the object to be measured with respect to the image acquisition apparatus are calculated by using positions of the identified markers in the image input, and the positional information of the markers with respect to the object to be measured.

Further, various rendering and interaction techniques have been explored. For example, some researchers have proposed an approach that makes use of autocalibrated features for rendering annotations into images of a scene as a camera moves about relative to the scene. Also, other researchers have tried laying an image of a desired user interface comprising input segments onto an image of a user's hand in such a way that segments of the user interface are separated from each other by the natural partition of the hand. The user sees this interface and selects a desirable segment by touching a partition on the hand. Still other researchers have design an information processing system that enables users to attach virtual information to situations in the real world and retrieve desired information. These researchers use IR beacons and bar code based fiducials (Cybercode) to identify positions and objects, respectively.

What is needed is an effective user interaction system for a user immersed in augmented reality. The present invention fulfills this need.

### SUMMARY OF THE INVENTION

In accordance with the present invention, an augmented reality user interaction system includes a wearable computer equipped with at least one camera to detect one or more fiducial markers worn by a user. In other aspects, a user-mounted visual display worn by the user is employed to display visual 3D information. In further aspects, the computer detects in an image a fiducial marker worn by the user, extracts a position and orientation of the fiducial marker in the image, and superimposes on the image a visual representation of a user interface component directly on or near the user based on the computed position and orientation.

The augmented reality user interaction system according to the present invention is advantageous over previous augmented reality user interfaces. For example, it allows users to interact with a virtual user interface in an intuitive manner. Yet, it does so in a reliable fashion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view showing a presently preferred embodiment of the augmented reality user interaction system, as seen from the viewpoint of a user of the system;

FIGS. 2A and 2B are side views illustrating components of the augmented reality user interaction system according to the present invention;

FIGS. 3A and 3B are perspective views illustrating the user's experience before and after the image augmentation process, wherein FIG. 3A illustrates a “real” image, with no augmentation, while FIG. 3B illustrates an overlaid graphical control panel that appears to hover over the user's hand; and

FIG. 4 is a flow diagram illustrating a method of operation for a computer processing component of the augmented reality user interaction system according to the present invention.

### DETAILED DESCRIPTION OF THE PREFERRED EMBODIMENT

The following description of the preferred embodiment is merely exemplary in nature and is in no way intended to limit the invention, its application, or uses.

The digital tattoos software and interaction technique allows a mobile user to see, touch, and generally interact with three dimensional menus, buttons, characters or other data objects that appear to be attached to the body. Key to the invention is a technique that uses the surface of the body and the immediate peripersonal space to organize virtual objects and information for user interaction. The technique makes virtual objects appear to be attached to the body or in near peripersonal space.

The software and interaction technique is implemented with the use of a wearable, augmented reality system. In this embodiment, novel imaging procedures are employed. In particular, a means for tracking a part of the body is used. In one embodiment, an optical, camera based tracking approach is used with fiducial markers. A fiducial marker is a specific pattern that appears on the physical surface and is used by a computer equipped with a camera and augmented reality processing software to establish a virtual 3D frame of reference for placing objects in virtual space. The computer is able to determine from the camera image exactly where the fiducial marker is on the body relative to the camera, which is fixed relative to the body or display. Given this information, the fiducial marker provides an anchor for the virtual augmentations that will be seen by the user. These augmentations seem to be attached to the marker image, which is, in turn, attached to the body. The effect is virtual user interface elements that appear to be attached to the body in near peripersonal space.

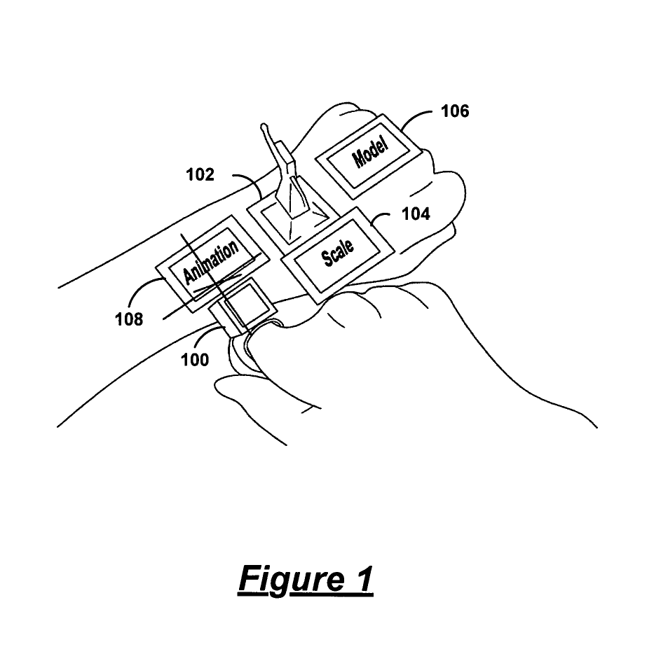

Turning now to FIG. 1, the perception of a hand with an attached marker image is augmented with user interface elements, in this case menu options that modify the presentation of an animated graph image that appears to hover just above the surface of the skin. This visual augmentation can be performed in many ways, including the modification of a camera image as in this example, the use of a head-mounted display that overlays the augmentations over the visual field, or using devices that project augmentations onto the surface of the hand.

According to the present invention, fiducial markers are used to link virtual objects to the body and can be attached to the body in any of a number of ways, including as a temporary tattoo, a permanent tattoo, or as a pattern printed on an item worn by a user, such as a watch, jewelry, or clothing. In the illustrative embodiment depicted in FIG. 1, a menu system is located on the hand. A temporary, stick-on tattoo bearing a fiducial marker 102 is placed on the back of the palm or inside the palm. Another fiducial marker 100 is attached to a ring to detect the location of the other hand as an interaction tool. Virtual menus and objects, such as animations 108, scales 104, and models 106 can be displayed to the user based on detected position and orientation of fiducial marker 102 as part of user interface. A virtual selection tool, such as a cursor, can be displayed to the user based on detected position and orientation of fiducial marker 100. Thus, with one hand bearing the virtual menus and objects and the other bearing a virtual cursor or other tools, users can use the hand with the ring to select, and interact with the virtual menus, buttons, objects, or animated characters attached to their other arm.

When the user views the hand, the camera sees the digital tattoo. The tattoo, in turn, allows the computer to create the registered virtual elements. For example, the system can detect the user interacting with a user interface component when the user positions and orients the two fiducials in a way that causes the virtual cursor to appear, from the user's perspective, to intersect the user interface component. Alternatively or additionally, interaction can include not only the use of a ring, but also occlusion of all or part of the tattoo, either by closing the hand, turning the hand so as to face the tattoo away from the camera, moving the hand behind an occluding object in space, or using some other body part to cause occlusion. For example, the user can cause the menu and cursor to appear by opening and closing the hand in view of the camera. A rhythmic repetition may be required in a fashion that can be considered analogous to double clicking with a mouse. Then, the user can employ the menu until finished, and cause it to disappear again. In yet other embodiments, the fiducial can be attached to a watch, bracelet, or sleeve in a concealable fashion. In this case, simply revealing and concealing the fiducial and placing it in view of the camera can cause the menu to appear and disappear.

It is envisioned that multiple digital tattoos can be used simultaneously for multiple, related functions. It is also envisioned than an image located inside the fiducial or near the fiducial can identify a data object to be displayed in relation to that fiducial. The computer can then determine the correct data object by extracting and recognizing the image content, and using it to retrieve the correct data object. In this way, a user can be permitted to customize their menu by physically rearranging the locations of the fiducials. It is further envisioned that the fiducials can be reattachably detachable for display and use in the user's environment, such as in the user's vehicle or at the user's desk.

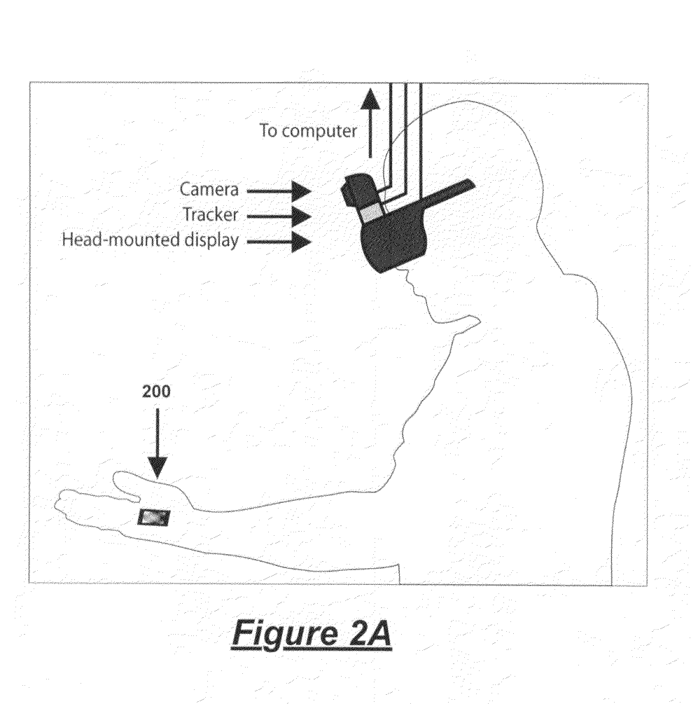

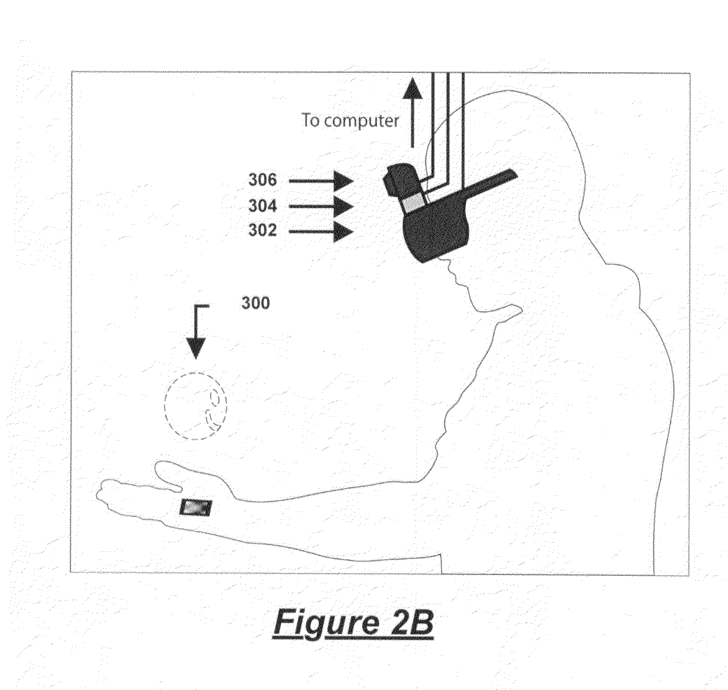

Turning now to FIGS. 2A and 2B, a wearable computer is equipped with at least one camera to detect the fiducials. A head-mounted visual display 302 is worn by a user and employed to display visual 3D information. In the preferred embodiment, the camera 306 and a stereo LCD display are worn on the head. A tracker 304 is also used. The computer detects the fiducial markers, such as marker 200, captured by the camera. The augmented reality software extracts the position and orientation of fiducials within view of the camera. The positional information is used to superimpose a user interface 300, such as menus, data objects, and other information, directly on or near the body and to trigger interactions. It is envisioned that one or more portions of the computer processing component of the present invention can be worn by the user, located near the user, or accessed over the Internet or other communication system. Preferably, at least part of the computer, such as the camera, is worn by the user. Images obtained by the camera can be transmitted either wired or wirelessly for processing.

As this paradigm is a general interaction paradigm, various kinds of interactions involving the seeing, hearing, or manipulation of virtual information located on or near any part of the body can be achieved. In part, the interaction paradigm involves the placement of a pattern onto the body in the form of a sticker, printed clothing, temporary tattoo, or permanent tattoo for the purposes of cuing a camera in support of user interface elements that appear to be attached to the human body.

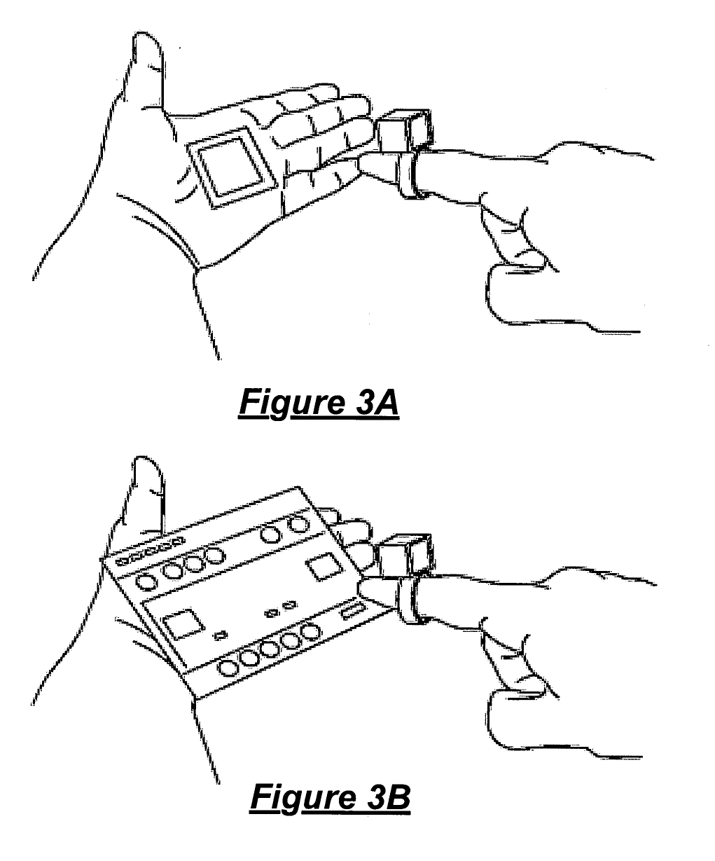

The interaction system operates by rendering computer graphic images such that they appear to be registered, for example, with the surface of the skin, thereby appearing to be parts of the hand as illustrated in FIGS. 3A and 3B, or some other body part. The method involves application of a marker image onto the user that can be reliably located by a computer and that provides sufficient information to support 3D graphics rendering that will be properly placed and oriented in relation to the marker image. These marker images are also referred to herein as fiducials.

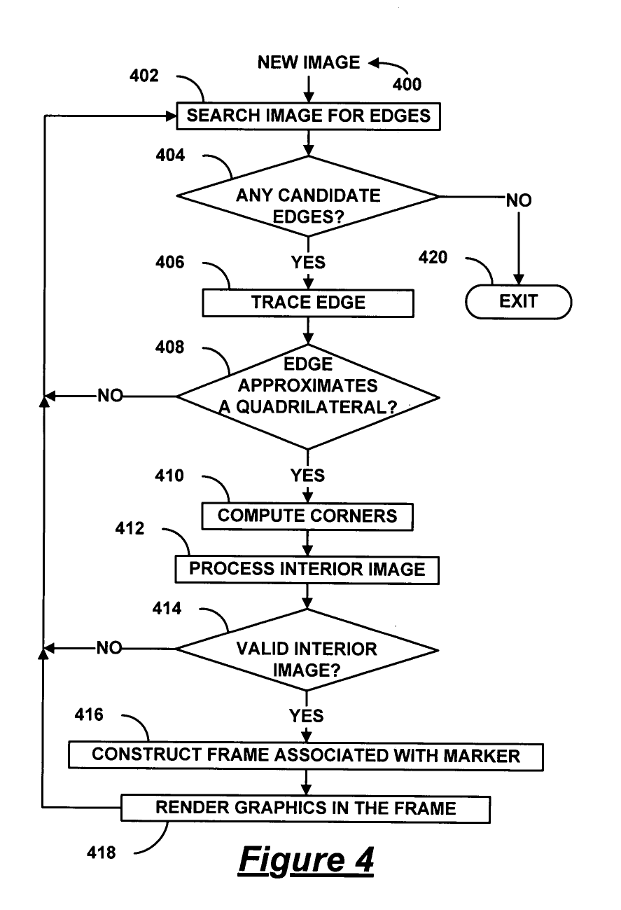

Turning now to FIG. 4, the first step in the method of operation for the interaction system is the acquisition of a digital image containing the marker image on the tattooed body part. This acquisition is typically accomplished using a digital video camera. It is this video image that is the input image 400.

The first step carried out by the computer processor is the location of a candidate edge for a marker image at step 402. Marker images in this embodiment are bounded by a square black border, though it is only necessary that the marker image have a contrasting boundary. A red marker on a blue background will be equally sufficient. Due to the dominance of the primary color red in skin tones, a blue image is a reasonable alternative to the described black fiducial.

Determination of a candidate edge can be conducted by scanning across rows of the image and looking for local transitions from the background color to the edge color. Several embodiments of this process have been tested including threshold changes in intensity and a difference in intensity from the local average. A candidate edge can be a single pixel location within an image that exhibits an adjacent change to the color of a marker edge.

The next test at decision step 404 is the possible exit point for the process. If no candidate edges have been detected, the process terminates until the next image acquisition. Once a candidate edge is located, the entire visual object edge is traced at step 406. This tracing process can include following the edge in a counter-clockwise direction, tracing the pixels that exhibit the edge property. This process is akin to left-wall following in a maze. For each pixel location there are eight adjacent pixels. One is the location the trace came from. The other seven pixels represent alternative paths in the tracing process. The path that will keep the candidate marker edge region to the left is chosen. This process continues until the trace returns to the starting location or exits the bounds of the image.

The traced edge can be represented by a chain code, a sequence of steps, each step in one of seven possible directions relative to the last pixel for a list of pixel coordinates. The edge is then tested to see if it approximates a quadrilateral at decision step 408. This process can include determining if a quadrilateral can be overlaid on the edge such that the edge does not deviate from the quadrilateral by more than a maximum distance determined by the noise tolerance of the capture process. It is common than many more candidate edges will be found than actual markers due to tracking of common objects within the image. These non-marker edges are rejected.

Once an approximate quadrilateral is verified, the corners of the quadrilateral are determined at step 410. All of the pixels along the four edges of the quadrilateral are used to determine an optimal line fitting in a least-squared sense. Four such lines are computed. The intersections of the four lines are the corners of the quadrilateral.

Given the known corners of the quadrilateral, the interior of the quadrilateral is warped into a square image at step 412. This process is performed by determining the appropriate mapping of pixels within the quadrilateral to corresponding locations in a square image. This image is then subject to an algorithm that determines if it is a correct interior image and the code for the interior image. Markers can consist of a border that can be easily located and an interior image that is designed to have a low correlation to random image data and be robustly identified by the camera. Associated with each interior image is an integer ID value.

Decision step 414 next determines if the interior image is valid. If the interior image is not valid, the image located is assumed to not be a marker and the location process continues. Otherwise, the marker is now considered to be a valid located marker.

Given the four corners of a marker, a frame can be uniquely computed at step 416. A frame is a specification of the location and orientation of the marker relative to the camera used to capture the image. Given a calibrated camera, knowledge of the dimensions of the physical marker, and the pixel locations of the four corners of the marker, the process of determining the frame is called P4P, which means Pose from 4 Points. This is a common computer vision problem for which many algorithms exist. In this embodiment, the solution is determined using an iterative solution based on computation of an optimum Jacobian (matrix of partial derivatives).

Once a frame is located, the graphics can be rendered so as to be accurately registered to the frame at step 418. If the rendering is performed on the camera image, as in a tablet computer, PDA, or cell phone image, the frame provides the exact location of the marker in the image and rendering is accomplished by simply transforming graphical objects to the marker frame. When external display devices are used, such as head-mounted displays, a transformation from the camera frame to the display frame is composed with the marker frame to achieve the appropriate display frame. The camera frame to display frame transformation is determined in the calibration process of an augmented reality system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An augmented reality user interaction system, comprising:
a wearable computer equipped with at least one camera to detect one or more fiducial markers worn by a user; and
a user-mounted visual display worn by the user and employed to display visual 3D information,
wherein said computer operably detects in an image including at least part of the user one or more fiducial markers worn by the user, extracts a position and orientation of a fiducial marker in the image, and superimposes on the image a visual representation of a user interface component directly on or near the user based on the position and orientation.

2. The system of claim 1, wherein said computer operably displays visual 3D information to the user including the image having the visual representation of the user interface component.

3. The system of claim 2, wherein said computer operably constructs a frame associated with the fiducial marker having a quadrilateral edge containing a valid square image, and operably renders graphics into the frame, including the visual representation of the user interface component.

4. The system of claim 3, wherein said computer operably searches the image for edges, determines whether there are any candidate edges, and traces a candidate edge.

5. The system of claim 4, wherein said computer operably determines whether there are any candidate edges by scanning across rows of the image and looking for local transitions from a background color to a predefined edge color.

6. The system of claim 3, wherein said computer operably determines whether a traced edge approximates a quadrilateral, and computes corners of an edge that has been determined to approximate a quadrilateral.

7. The system of claim 6, wherein said computer operably determines whether a traced edge approximates a quadrilateral by determining if a quadrilateral can be overlaid on the edge such that the edge does not deviate from the quadrilateral by more than a maximum distance determined by a noise tolerance of a capture process employed to capture the image.

8. The system of claim 6, wherein said computer operably computes corners of an edge that has been determined to approximate a quadrilateral by employing all pixels along all four edges of the quadrilateral to determine an optimal line fitting in a least-squared sense by computing four such lines and interpreting intersections of the four lines as the corners of the quadrilateral.

9. The system of claim 3, wherein said computer operably processes an interior of the quadrilateral edge into a square image, and determining whether the square image is valid.

10. The system of claim 9, wherein said computer operably processes an interior of the quadrilateral edge into a square image by warping a portion of the image enclosed by the quadrilateral edge into the square image by determining a mapping of pixels within the quadrilateral edge to corresponding locations in the square image.

11. The system of claim 9, wherein said computer operably determines whether the square image is valid by determining whether the square image matches one of plural predefined images selected to have low correlations to random image data.

12. The system of claim 1, further comprising detecting user interaction with the visual representation of the user interface component based on detected position and orientation of another fiducial marker worn by the user.

13. The system of claim 12, wherein said computer operably superimposes a visual representation of a cursor at or near the other fiducial marker; and detects user interaction with the visual representation of the user interface component when the user manipulates the other fiducial marker to cause the visual representation of the cursor to appear to the user to interact with the visual representation of the user interface component in a predetermined fashion.

14. The system of claim 12, wherein said computer operably detects the fiducial marker on or near one hand of the user, and detects the other fiducial marker on a ring worn on another hand of the user.

15. The system of claim 1, wherein said computer operably detects user interaction with the visual representation of the user interface component based on user occlusion of the fiducial marker with respect to which the visual representation of the user interface component is visually rendered.

16. The system of claim 1, wherein said computer operably triggers a predetermined interaction when the user interacts with the visual representation of the user interface component.

17. The system of claim 1, wherein said computer operably extracts and recognizes image content located inside or near the fiducial marker, and determines which of plural user interface components to display in relation to the fiducial marker based on the image content.

18. The system of claim 1, wherein said computer operably detects the fiducial marker attached to skin of at least one of a hand, wrist, or arm of the user.

19. The system of claim 1, wherein said computer operably detects the fiducial marker on clothing worn by the user.

20. The system of claim 1, wherein said computer operably detects the fiducial marker on at least one of a watch or jewelry worn by the user.

21. An augmented reality user interaction method, comprising:
visually detecting in an image, including at least part of the user, one or more fiducial markers worn by the user;
extracting a position and orientation of a fiducial marker in the image; and
superimposing on the image a visual representation of a user interface component directly on or near the user based on the position and orientation.

22. The method of claim 21, further comprising displaying visual 3D information to the user including the image having the visual representation of the user interface component.

23. The method of claim 22, further comprising:
constructing a frame associated with the fiducial marker having a quadrilateral edge containing a valid square image; and
rendering graphics into the frame, including the visual representation of the user interface component.

24. The method of claim 23, further comprising:
searching the image for edges;
determining whether there are any candidate edges; and
tracing a candidate edge.

25. The method of claim 24, wherein determining whether there are any candidate edges includes scanning across rows of the image and looking for local transitions from a background color to a predefined edge color.

26. The method of claim 23, further comprising:
determining whether a traced edge approximates a quadrilateral; and
computing corners of an edge that has been determined to approximate a quadrilateral.

27. The method of claim 26, wherein determining whether a traced edge approximates a quadrilateral includes determining if a quadrilateral can be overlaid on the edge such that the edge does not deviate from the quadrilateral by more than a maximum distance determined by a noise tolerance of a capture process employed to capture the image.

28. The method of claim 26, wherein computing corners of an edge that has been determined to approximate a quadrilateral includes employing all pixels along all four edges of the quadrilateral to determine an optimal line fitting in a least-squared sense by computing four such lines and interpreting intersections of the four lines as the corners of the quadrilateral.

29. The method of claim 23, further comprising:
processing an interior of the quadrilateral edge into a square image; and
determining whether the square image is valid.

30. The method of claim 29, wherein processing an interior of the quadrilateral edge into the square image includes warping a portion of the image enclosed by the quadrilateral edge into the square image by determining a mapping of pixels within the quadrilateral edge to corresponding locations in the square image.

31. The method of claim 29, wherein determining whether the square image is valid includes determining whether the square image matches one of plural predefined images selected to have low correlations to random image data.

32. The method of claim 21, further comprising detecting user interaction with the visual representation of the user interface component based on detected position and orientation of another fiducial marker worn by the user.

33. The method of claim 32, further comprising:
superimposing a visual representation of a cursor at or near the other fiducial marker; and
detecting user interaction with the visual representation of the user interface component when the user manipulates the other fiducial marker to cause the visual representation of the cursor to appear to the user to interact with the visual representation of the user interface component in a predetermined fashion.

34. The method of claim 32, further comprising:
detecting the fiducial marker on or near one hand of the user; and
detecting the other fiducial marker on a ring worn on another hand of the user.

35. The method of claim 21, further comprising detecting user interaction with the visual representation of the user interface component based on user occlusion of the fiducial marker with respect to which the visual representation of the user interface component is visually rendered.

36. The method of claim 21, further comprising triggering a predetermined interaction when the user interacts with the visual representation of the user interface component.

37. The method of claim 21, further comprising employing a camera worn by the user to capture the image including at least part of the user.

38. The method of claim 21, further comprising employing a visual display worn by the user to display visual 3D information to the user including the image having the visual representation of the of the user interface component.

39. The method of claim 21, further comprising:
extracting and recognizing image content located at least one of inside or near the fiducial marker; and
determining which of plural user interface components to display in relation to the fiducial marker based on the image content.

40. The method of claim 21, further comprising detecting the fiducial marker attached to skin of at least one of a hand, wrist, or arm of the user.

41. The method of claim 21, further comprising detecting the fiducial marker on clothing worn by the user.

42. The method of claim 21, further comprising detecting the fiducial marker on at least one of a watch or jewelry worn by the user.
